(19) United States
(12) Patent Application Publication
(10) Pub. No.: US 2016/0181845 A1
(43) Pub. Date: Jun. 23, 2016

(54) METHOD AND APPARATUS FOR BATTERY MANAGEMENT WITH THERMAL CONTROL

(71) Applicants: Joshua Alan Resnick, Kodiak, AK (US); Seth Michael McGann, Kodiak, AK (US)

(72) Inventors: Joshua Alan Resnick, Kodiak, AK (US); Seth Michael McGann, Kodiak, AK (US)

(21) Appl. No.: 14/580,764

(22) Filed: Dec. 23, 2014

(51) Int. Cl. H02J 7/00

(52) U.S. Cl. CPC H02J 7/0063; H02J 7/007; H02J 2007/0067

(57) ABSTRACT

A method and apparatus for controlling the temperature of a battery during discharge cycles. Battery temperature is reported to a controller that returns a shunt current indicator. Heat is generated as the battery is discharged according to the shunt current indicator. This heat is then applied to the terminal of a battery.

### BACKGROUND

There are numerous methods for managing batteries during a charge cycle and during a discharge cycle. Typically, large energy storage systems rely upon series connected batteries to achieve higher voltages for delivery to a load. As such, it is necessary to ensure that each battery included in such a series connected battery pack (SCBP) is charged to a substantially equal level during the charge cycle. Likewise, it is also necessary to ensure that the charge on each battery included in such a series connected battery pack is drained at a substantially equivalent rate during the discharge cycle.

Is well-known that temperature amongst the individual batteries in an SCBP can vary. It is also well-known that the temperature of a battery is just one of the factors that dictates the effectiveness of a battery. In an SCBP, variation of the battery temperatures means that different batteries in the SCBP will be charged at different rates and, of course, will be discharged at different rates because of the temperature variation amongst individual batteries in the SCBP. The SCBP, as a whole, is also affected by the ambient temperature it is subject to during operation. Because batteries are not as effective at colder temperatures, batteries around the peripheral of the SCBP may not be charged or discharged as effectively as other batteries in the SCBP that may be surrounded by other batteries. As such, the overall effectiveness of the SCBP is compromised.

In order to manage the thermal characteristics of an SCBP, some implementations use temperature sensors that are placed in between batteries so that the temperature at different points in the SCBP can be monitored. Then, based on the temperature, adjustments can be made in charging and discharging profiles of the battery pack as a whole. In yet other implementations, heating elements are distributed within a battery pack based on empirical observations of the temperature profile as the battery pack operates in its ambient environment. This, of course, does not consider that individual batteries in an SCBP may be operating at different temperatures because of their positioning within the battery pack or because of the self-heating that each battery exhibits during its charge or discharge cycles. More problematic is the fact that only a few temperature sensors are typically included in an SCBP and only a handful of heating elements are distributed within the battery pack. In these prior art implementations, there is simply no mechanism by which variations of temperature within the SCBP can be accounted for.

### BRIEF DESCRIPTION OF THE DRAWINGS

Several alternative embodiments will hereinafter be described in conjunction with the appended drawings and figures, wherein like numerals denote like elements, and in which:

FIG. 1 is a pictorial of a plan view of one example embodiment of a battery management module;

FIG. 2 is a flow diagram that depicts one example method for managing battery charge and discharge with concurrent thermal control;

FIG. 3 is a flow diagram that depicts one alternative example method for discharging a battery;

FIG. 4 is a flow diagram that depicts one alternative example method for applying heat to a battery;

FIG. 5 is a flow diagram that depicts one alternative example method for managing excessive battery temperature;

FIG. 6 is flow diagram that depicts one alternative example method for removing heat from a battery terminal;

FIG. 7 is a flow diagram that depicts yet another alternative example method for removing heat from a battery terminal;

FIG. 8 is a pictorial diagram that depicts one illustrative use scenario for a battery management module;

FIG. 9 is a pictorial diagram that depicts yet another illustrative use scenario for a battery management module;

FIG. 10 is a block diagram that depicts one alternative embodiment of a module manager that is based on a processor; and

FIG. 11 is a data flow module that depicts the operation of a processor based module manager.

### DETAILED DESCRIPTION

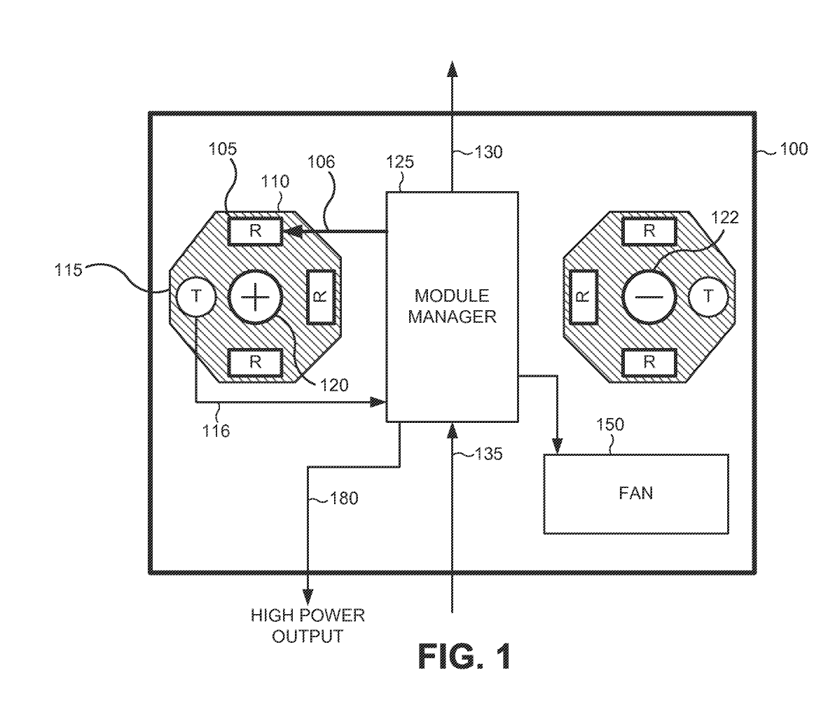

FIG. 1 is a pictorial of a plan view of one example embodiment of a battery management module. It should be appreciated that, in one alternative example embodiment, the battery management module 100 is structured on a printed circuit board. In such an alternative example embodiment, the battery management module 100 includes a battery terminal connector 120. Typically, the battery management module 100 includes a positive battery terminal connector 120 and a negative battery terminal connector 122. According to this one example embodiment, a battery management module 100 includes a module manager 125. The battery management module 100 includes a data interface 130. In one alternative example embodiment, the data interface 130 is bidirectional. As such, a bidirectional data interface 130 may be used to convey information from the module manager 125 and may also be used to receive information into the module manager 125. In one alternative example embodiment, a second data interface 135 is also included. In this alternative example embodiment, the first interface 130 is used to convey information from the module manager 125 and the second data interface 135 is used to receive information into the module manager 125.

In this example embodiment, the battery management module 100 also includes a heating element 105. In one alternative example embodiment, the heating element comprises a resistor. In this example embodiment, the module manager 125 controls the heating element 105 by means of an enablement signal 106. In this example embodiment, the battery management module 100 also includes a thermal sensor 115. In this example embodiment, the module manager 125 receives thermal information from the thermal sensor 115 by way of a thermal sensor interface 116. In operation, the module manager 125, in this example embodiment, conveys the thermal information to an external controller by way of the data interface 130. Using the same data interface 130, or in an alternative example embodiment, a second data interface 135, the module manager 125 receives a shunt current indicator from the external controller. In this alternative example embodiment, the module manager 125 then enables the heating element 105 according to the shunt current indicator received by the module manager 125.

It should be appreciated that, according to various illustrative use cases, the data provided to the external controller and received from the external controller can in fact be conveyed to any type of device that satisfies particular requirements for determining a particular shunt current value based on a thermal value provided by the module manager 125. As such, the claims appended hereto are not intended to be limited in scope by the type of external controller or other device with which the module manager 125 included in the battery management module 100 is in communication with.

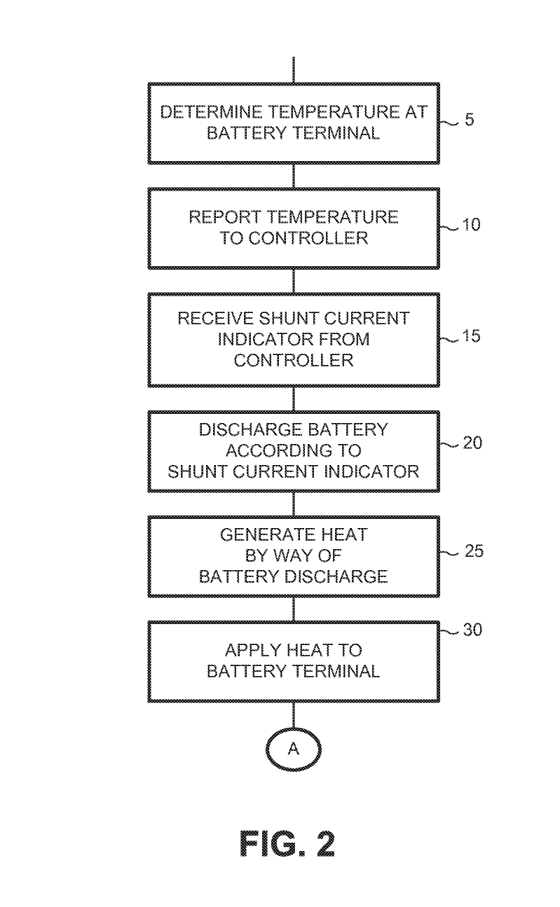

FIG. 2 is a flow diagram that depicts one example method for managing battery charge and discharge with concurrent thermal control. It should be appreciated that, according to this example method, a temperature of a battery is determined by determining the temperature at a battery terminal connector (step 5). As depicted in FIG. 1, one alternative example embodiment of a battery management module 100 includes a thermal sensor 115 that is physically proximate to a battery terminal connector 120. It should be appreciated that the thermal sensor 115, according to one alternative example embodiment, is disposed proximate to at least one of a positive battery terminal connector 120 and a negative battery terminal connector 122. According to this example method, the temperature at the battery terminal connector is then conveyed to a controller (step 10). Although not part of the battery management module method per se, the controller determines a shunt current value based on the thermal reading it receives from the battery management module. Continuing with the present method, a shunt current indicator is received from the controller (step 15).

In this example method, the battery which is being controlled by the battery management module 100 is then discharged according to the shunt current indicator (step 20). Heat is then generated using the current drained from the battery according to the shunt current indicator (step 25). The heat that is generated is then applied to the battery terminal connector (step 30). It should be appreciated that, by applying heating directly to the battery terminal connector, the heat transfer to the core of the battery is much more effective than prior art methods where heating elements are simply disposed at a surface of a battery, for example on a plastic case that is used to enclose the battery core.

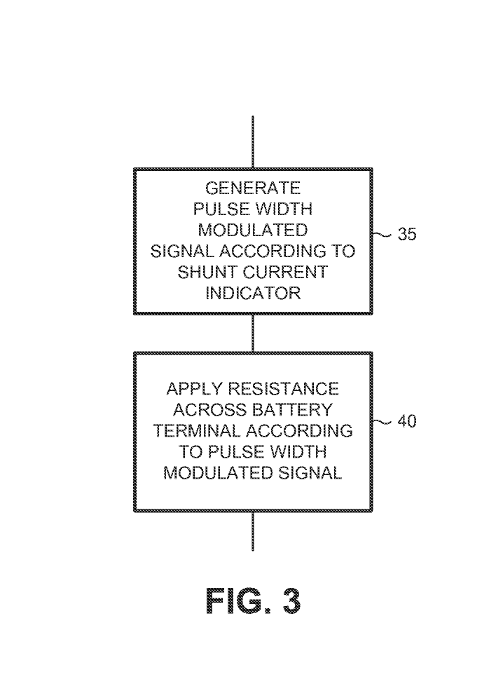

FIG. 3 is a flow diagram that depicts one alternative example method for discharging a battery. In this alternative example method, a pulse width modulated signal is generated according to the shunt current indicator (step 35). It should be appreciated that the pulse width modulated (PWM) signal comprises a duty cycle based signal where the signal is enabled for a period of time and then disabled for a second period of time on a periodic basis. In this alternative example method, a resistance is applied across the battery according to the pulse width modulated signal (step 40).

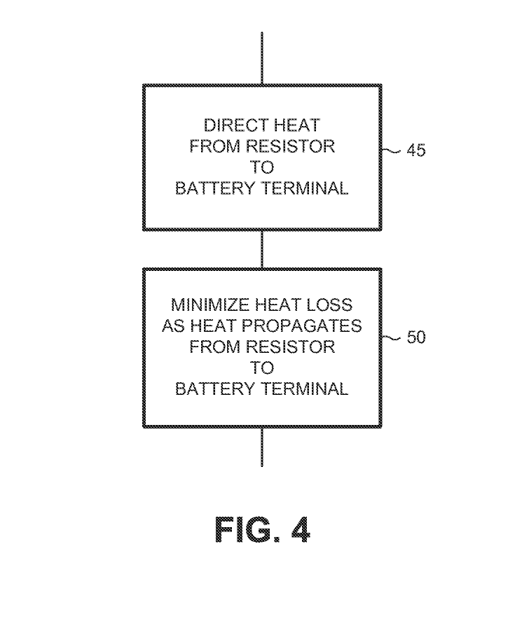

FIG. 4 is a flow diagram that depicts one alternative example method for applying heat to a battery. In this alternative example method, heat generated by the resistor that is enabled by the PWM signal is directed to the battery terminal connector (step 45). In this alternative example method, losses in the heat path from the resistor to the battery terminal connector are minimized (step 50) in order to provide for more efficient heating of the battery.

FIG. 1 further illustrates that the battery management module 100, in one alternative embodiment, includes a heat conduction structure 110 that facilitates the flow of heat from the heating element 105 to the battery terminal connector 120. It should be appreciated that this structure, in an alternative embodiment, is disposed about at least one of the positive battery terminal connector 120 and the negative battery terminal connector 122.

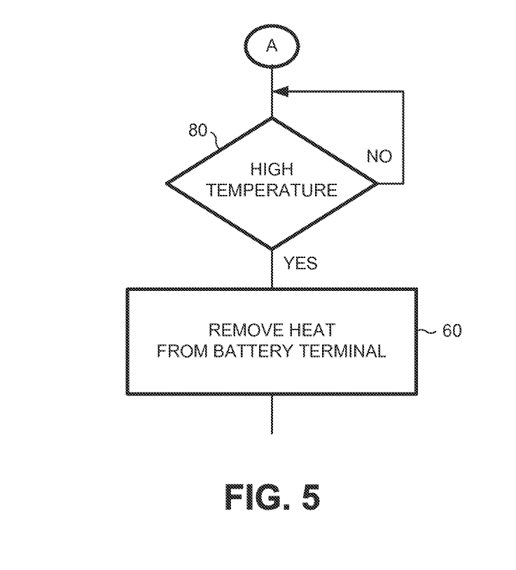

FIG. 5 is a flow diagram that depicts one alternative example method for managing excessive battery temperature. In this alternative example method, when the temperature of at least one of the positive battery terminal connector and the negative battery terminal connector exceeds a pre-established threshold (step 80), then heat is removed from at least one of the positive battery terminal connector and the negative battery terminal connector (step 60).

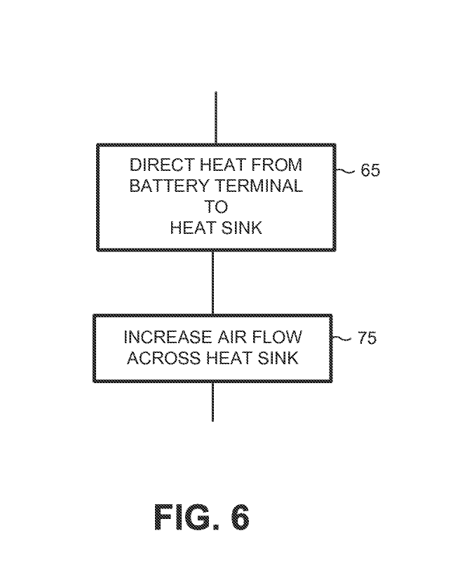

FIG. 6 is flow diagram that depicts one alternative example method for removing heat from a battery terminal. In this alternative example method, heat from the battery terminal is directed to a heat sink (step 65). In order to remove heat from the heat sink, airflow across the heat sink is increased (step 75) so as to promote dissipation of heat from the heat sink into the ambient environment. In one example embodiment, increasing airflow across the heat sink is accomplished by means of a fan. It should be appreciated that the increase of airflow is enabled when the temperature of at least one of the positive battery terminal connector and the negative battery terminal connector exceeds a pre-established threshold, as depicted in Step 80 in FIG. 5.

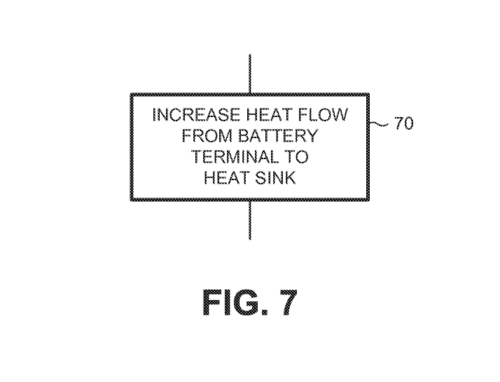

FIG. 7 is a flow diagram that depicts yet another alternative example method for removing heat from a battery terminal. In this alternative example method, heat from the battery terminal is encouraged to flow into a heat sink (step 70). This, in one alternative embodiment, is accomplished by means of a device that can be enabled and which operates as a heat pump. In one alternative embodiment, such a device comprises a thermoelectric cooler that, upon application of electric current to the thermoelectric cooler, encourages the migration of heat from a first surface to a second surface, said surfaces disposed in opposition to each other. Accordingly, one surface of the thermal electric cooler is mechanically coupled to the battery terminal and the second surface of the thermoelectric cooler is mechanically coupled to a heat sink.

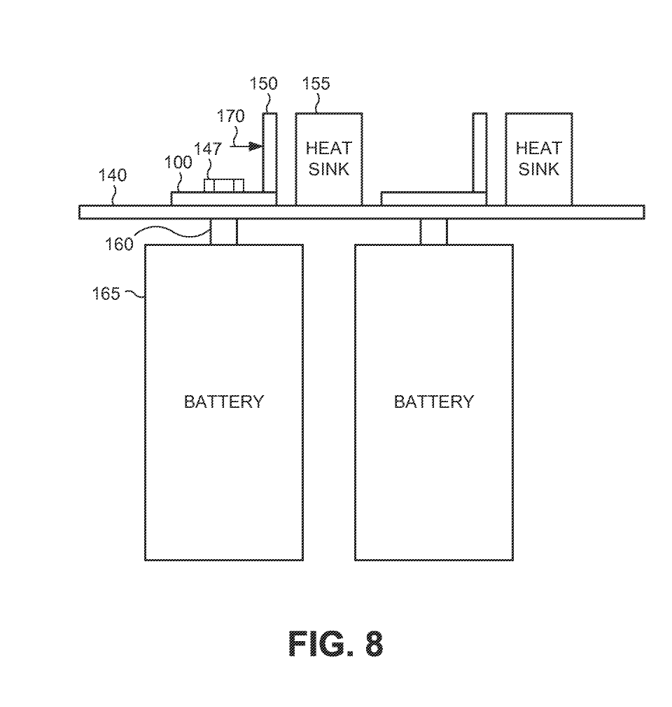

FIG. 8 is a pictorial diagram that depicts one illustrative use scenario for a battery management module. FIG. 8 also depicts one alternative example embodiment of a battery management module. It should be appreciated that a battery 165 includes at least two terminals by which charge is directed into the battery or drawn from the battery. It is common knowledge that batteries store a direct current (DC) charge and that at least one terminal of the battery is dedicated to a positive terminal and at least one terminal of the battery is dedicated to a negative terminal. In this illustrative use scenario, a power bus 140 is mechanically coupled to at least one of a positive battery terminal and a negative battery terminal. For the purpose of illustration, the terminals of either polarity are identified by reference designator 160.

The battery management module 100, in this illustrative diagram, is placed on top of the power bus 140. To ensure proper mechanical and electrical connection between the battery terminal connector included in a battery management module 100, the power bus 140 and the battery terminal 165 a force is a applied by means of a fastener 147, for example a threaded machine screw. By ensuring good mechanical connection between the battery terminal 165 and the power bus 140, heat may be removed from the battery terminal 160 and directed through the power bus 140 to a heat sink 155, which is mounted to the power bus 140. It should be appreciated that various alternative illustrative uses are contemplated and the example of a threaded machines screw is merely one example of a fastener that is used to provide mechanical retention of the battery management module 100, the power bus 140 and the battery terminal 160. Accordingly, the claims appended hereto are not intended to be limited in scope to any particular example thus far described.

FIGS. 1 and 8 also depict an alternative example embodiment of a battery management module 100 that further includes a fan 150. In yet another alternative example embodiment, the battery management module 100 further includes a high-power output 180. It can be appreciated that, according to various illustrative use scenarios, the high-power output can be used to enable a fan that is used to increase airflow across a heat sink.

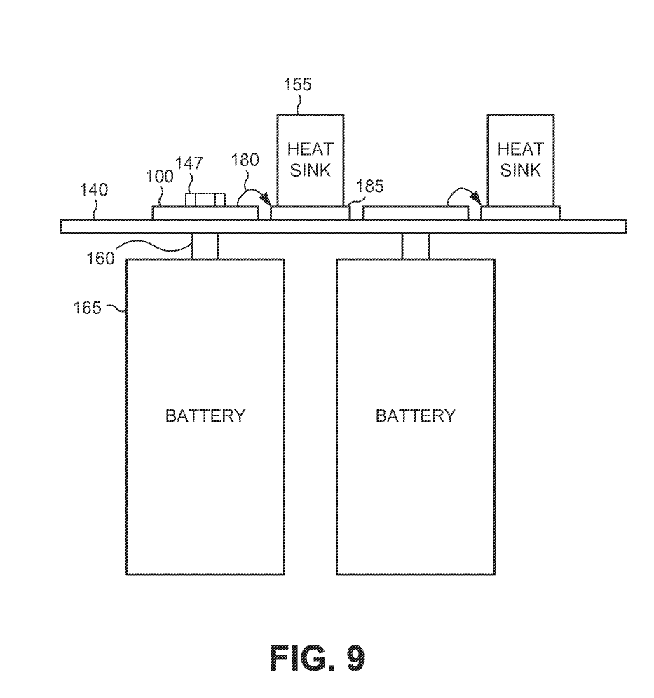

FIG. 9 is a pictorial diagram that depicts yet another illustrative use scenario for a battery management module. In this alternative use scenario, a heat sink 155 is installed upon a thermoelectric cooler 185. In this illustrative use scenario, the thermoelectric cooler 185 is then mounted upon the power bus 140. To enable the thermoelectric cooler 185, the high-power output 180 from the battery management module 100 is used in this illustrative use scenario.

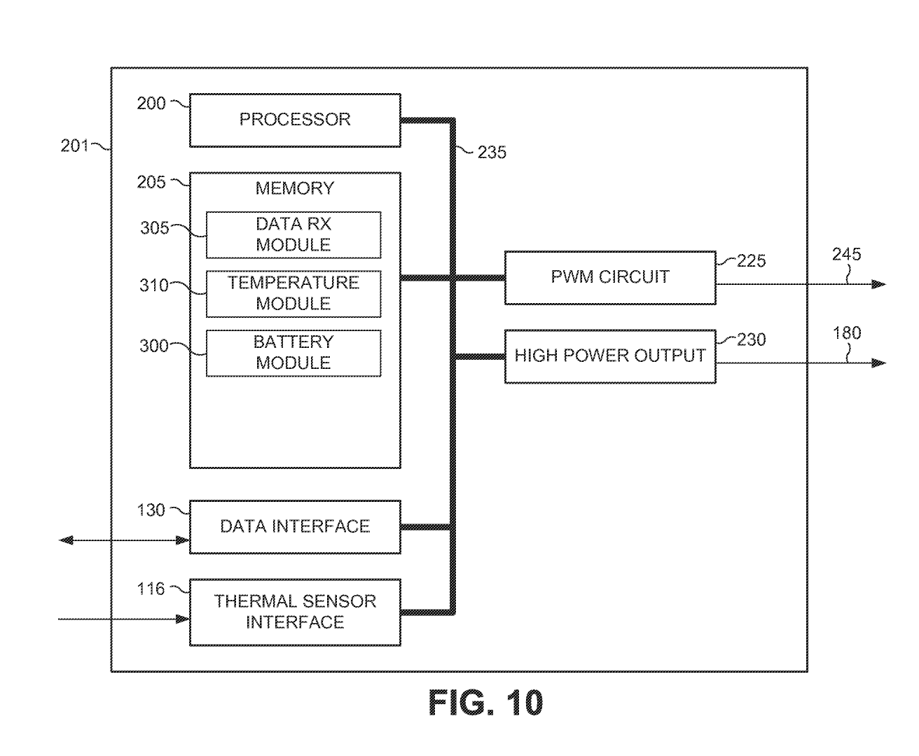

FIG. 10 is a block diagram that depicts one alternative embodiment of a module manager that is based on a processor. In this alternative embodiment of a module manager 100, the module manager comprises a processor based module manager 201. In this alternative embodiment, the module manager 201 includes a processor 200, a memory 205, a data interface 130 and a thermal sensor interface 116. The memory 205 is used to store various functional modules including a data reception module 305, a battery control module 300 and a temperature module 310.

A functional module is typically embodied as an instruction sequence. An instruction sequence that implements a functional module, according to one alternative embodiment, is stored in the memory 205. The reader is advised that the term “minimally causes the processor” and variants thereof is intended to serve as an open-ended enumeration of functions performed by the processor 200 as it executes a particular functional module (i.e.

instruction sequence). As such, an embodiment where a particular functional module causes the processor 200 to perform functions in addition to those defined in the appended claims is to be included in the scope of the claims appended hereto.

The functional modules (i.e. their corresponding instruction sequences) described thus far that enable battery management according to the present method are, according to one alternative embodiment, imparted onto computer readable medium. Examples of such medium include, but are not limited to, random access memory, read-only memory (ROM), programmable read only memory, flash memory, electrically erasable programmable read only memory, compact disk ROM (CD ROM), floppy disks, hard disk drives, magnetic tape and digital versatile disks (DVD). Such computer readable medium, which alone or in combination can constitute a stand-alone product and can be used to convert a general-purpose computing platform into a device capable of battery management according to the techniques and teachings presented herein. Accordingly, the claims appended hereto are to include such computer readable medium imparted with such instruction sequences that enable execution of the present method and all of the teachings herein described.

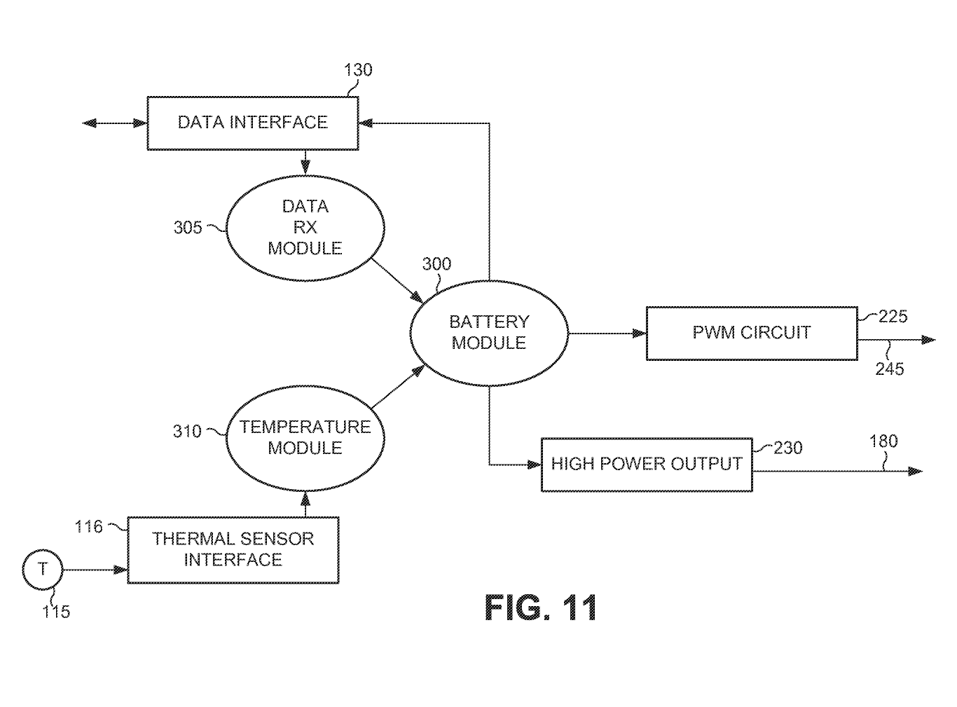

FIG. 11 is a data flow module that depicts the operation of a processor based module manager. In operation, the processor 200, as it executes the data reception module 305, is minimally caused to receive a shunt current indicator by way of the data interface 130. The processor 200, as it continues to execute the data reception module 305, makes the shunt current indicator ready for use by the processor 200 as it executes the battery control module 300. Typically, the data reception module 305, when executed by the processor 200, minimally causes the processor 200 to control the hardware aspects of the data interface 130. The processor 200, as it continues to execute the battery control module 300, is further minimally caused to use the current indicator, which may be in the form of a current level value, to establish a pulse with modulation level, which the processor 200 directs to a PWM circuit 225 that is included in this alternative example embodiment of a processor based module manager 201.

The battery control module of this particular alternative embodiment, once executed by the processor 200, further minimally causes the processor to execute the temperature module 310. The temperature module 310, as it is executed by the processor 200, further minimally causes the processor to receive a thermal value from the thermal sensor interface 116. In various alternative embodiments, the thermal sensor interface comprises an analog and digital converter and the value received from the analog and digital converter must be converted to a temperature value, which is accomplished by the processor 200 as it continues to execute the temperature module 310. In yet other alternative embodiments, the thermal sensor interface comprises a digital interface, for example an I2C serial data bus. In this alternative embodiment, the temperature module 310, as it is executed by the processor 200, further minimally causes the processor 200 to convert an I2C data packet into a temperature value.

Once the processor 200, as it continues to execute the battery control module 300, receives a temperature value from the temperature module 310, the processor 200 will direct the temperature value to the data interface 130. This affects the transfer of the temperature value to an external controller, which then can determine a shunt current level based on the temperature it receives.

In yet another alternative example embodiment, the processor 200, as it executes the battery control module 300, further minimally determines if the temperature of the battery exceeds a pre-established threshold. When this condition is present, the processor 200, as it continues to execute the battery control module 300, will enable the high-power output 230 so as to enhance heat flow from the battery terminal. As already described, the high-power output 230 can be used to enable a fan or a thermoelectric cooling device.

While the present method and apparatus has been described in terms of several alternative and exemplary embodiments, it is contemplated that alternatives, modifications, permutations, and equivalents thereof will become apparent to those skilled in the art upon a reading of the specification and study of the drawings. It is therefore intended that the true spirit and scope of the claims appended hereto include all such alternatives, modifications, permutations, and equivalents.

1. A method for battery management with thermal control comprising:
determining the temperature at a battery terminal included in a battery;
reporting the temperature to a controller;
receiving a shunt current indicator from the controller;
discharging the battery according to the shunt current indicator;
generating heat by way of the battery discharge; and
applying the heat to the battery terminal.

2. The method of claim 1 wherein discharging the battery comprises:
generating a pulse width modulated signal based on the shunt current indicator; and
applying a resistance across the battery according to the pulse width modulated signal.

3. The method of claim 1 wherein applying heat to the battery terminal comprises:
directing heat from a resistor disposed across the battery to the battery terminal; and
minimizing the loss of heat as the heat propagates from the resistor to the battery terminal.

4. The method of claim 1 further comprising:
removing heat from the battery terminal when the temperature at the battery terminal exceeds a threshold.

5. The method of claim 4 wherein removing heat comprises:
directing heat from the battery terminal to a heat sink; and
increasing the amount of air flow across the heat sink.

6. The method of claim 4 wherein removing heat comprises increasing the flow of heat from the battery terminal to a heat sink.

7. A battery management module comprising:
positive battery terminal connector;
negative battery terminal connector;
temperature sensor disposed so as to measure the temperature of at least one of the positive battery terminal connector and the negative battery terminal connector;
data interface;
module manager communicatively coupled to the data interface wherein said module manager receives a temperature value from the temperature sensor and conveys the temperature value to the data interface and wherein the module manager further receives a shunt current indicator from the data interface; and
heating element that is disposed proximate to at least one of the positive battery terminal and the negative battery terminal and which is enabled by the module manager according to the shunt current indicator and which discharges the battery when it is enabled.

8. The battery management module of claim 7 wherein the module manager generates a pulse width modulated signal according to the shunt current indicator and wherein the heating element comprises:
switch that is periodically enabled according to the pulse width modulated signal; and
resistor that is connected across the positive and negative battery terminals when the switch is enabled and which is disposed proximate to at least one of the positive battery terminal and the negative battery terminal.

9. The battery management module of claim 7 further comprises a heat conduction path disposed between the heating element and at least one of the positive battery terminal and the negative battery terminal.

10. The battery management module of claim 7 further comprising a heat removal signal that is enabled by the module manager when the temperature value exceeds a pre-established threshold.

11. The battery management module of claim 10 further comprising a fan that is enabled by the heat removal signal.

12. The battery management module of claim 7 wherein the module manager comprises:
at least one of a high power output and pulse width modulation circuit;
processor;
memory; and
one or more modules stored in the memory including:
data receiver module that, when execute by the processor, minimally causes the processor to receive a shunt current indicator using the data interface;
temperature module that, when executed by the processor, minimally causes the processor to receive a temperature reading from the thermal sensor interface; and
battery control module that, when executed by the processor, minimally causes the processor to convey to the data interface the temperature reading it receives from the temperature module and wherein the battery modules further minimally causes the processor to discharge the battery by enabling the heating element using at least one of the high power output and the pulse width modulation circuit according to the received shunt current indicator.

13. The battery management module of claim 12 wherein the battery control module, when executed by the processor, further minimally causes the processor to enable the high power output when the temperature reading exceeds a pre-established value.

14. A battery management module comprising:
means for determining the temperature of a battery terminal;
means for reporting the temperature to a controller;
means for receiving a shunt current indicator;
means for discharging the battery according to the shunt current indicator;
means for generating heat by using the means for discharging the battery; and
means for applying the heat to the battery terminal.
